(19) United States
(12) Patent Application Publication
(10) Pub. No.: US 2014/0136985 A1
(43) Pub. Date: May 15, 2014

(54) METHOD AND SYSTEM FOR SHARING CONTENT

(71) Applicant: MOONDROP ENTERTAINMENT, LLC, San Francisco, CA (US)

(72) Inventors: Ana Albir, San Francisco, CA (US); Kunal Jham, San Francisco, CA (US)

(73) Assignee: MOONDROP ENTERTAINMENT, LLC, San Francisco, CA (US)

(21) Appl. No.: 13/674,334

(22) Filed: Nov. 12, 2012

(51) Int. Cl. H04L 29/08

(52) U.S. Cl. CPC H04L 67/02
USPC 715/748

(57) ABSTRACT

A method disclosed herein includes graphically representing one or more members of a user's network together with a content, receiving a user input from the user with respect to the graphical representation of the content, the user input having a directionality, and communicating the content to a member of the user's network represented by a direction represented by the directionality. An implementation of the method further allows the members of the user's network to lend, share, and/or gift resources to each other using a graphical user interface. Yet alternative implementation of the method allows displaying the member network at different prominence levels in response to a user input on the graphical user interface.

### FIELD

Implementations disclosed herein relate, in general, to the information management technology and specifically to technology for method and system for sharing content.

### SUMMARY

A method disclosed herein includes graphically representing one or more members of a user's network together with a content, receiving a user input from the user with respect to the graphical representation of the content, the user input having a directionality, and communicating the content to a member of the user's network represented by a direction represented by the directionality. An implementation of the method further allows the members of the user's network to lend, share, and/or gift resources to each other using a graphical user interface. Yet alternative implementation of the method allows displaying the member network at different prominence levels in response to a user input on the graphical user interface.

In an implementation, the content is at least one of (1) a user generated content (UGC); (2) a content from a website; (3) a content stored on the user device; and (4) a network content downloaded from a network. In an alternative implementation, graphically representing one or more members of a user's network together with the content further comprises graphically representing one or more members of a user's network together with the content using at least one of (1) a tablet device; (2) a smartphone; and (3) a computer. In yet alternative implementation, the method further comprises allowing the user to add an object to the content, the object being at least one of (1) an audio content, (2) a video content, (3) an audio-visual content, (4) a pictorial content; and (5) a combination content.

In yet alternative implementation, the method further comprises determining a relationship health score between the user and a member of the user's network based on interactions between the user and the member. In an alternative implementation, the method further includes changing a display of the member of the users' network based on the relationship health score. Yet alternatively, the method further comprises receiving an updated content from the member of the user's network, modifying the graphical representation of the content with the graphical representation of the updated content, and modifying one or more metadata attached to the content. Yet alternatively, the method further comprises determining network connectivity of the user, and if the user has network connectivity, communicating the content to the member of the user's network, and if the user does not have network connectivity, storing the content to a user device. In an alternative implementation, the method further comprises monitoring the network connectivity of the user if the use does not have network connectivity and communicating the content from the user device to the member of the user's network upon detecting activation of the network connectivity of the user.

In an alternative implementation, the method further comprises determining the one or more members of the user's network based on a geographic distance of the one or more members from the user. Alternatively, the one or more members of the user's network based on an affiliation of the one or more members in a group related to the user. Yet alternatively, the method comprises graphically representing one or more members of a user's network together with a content and a graphical representation of a resource, receiving an input from the user with respect to the graphical representation of the resource, the input having a directionality, communicating the resource to a member of the user's network displayed in a direction represented by the directionality, and modifying the graphical representation of the resource to show the resource being unavailable to a user. In an alternative implementation, such resource is configured to allow the user to make a change to the content. Such communicating the content may be a gifting of the content or the lending of the content. Furthermore, such lending may be terminated based on geographic distance between the members or after a predetermined time period. In an implementation, a user communicating the resource is not able to use the content.

In an alternative implementation, the input may be any of (1) a pinching gesture using two fingers; (2) a double-click using a mouse; (3) a single-tap on the content, and (4) a double-tap on the content using two fingers, (5) a swiping gesture. Yet alternatively, the method disclosed herein comprises graphically representing a content and a member network using graphical representation of one or more members of the member network, wherein the graphical representation of the member network is at an initial prominence level compared to the content, receiving a user input from a user with respect to the graphical representation of the content, and in response to the user input, displaying the member network at a prominence level higher than the initial prominence level with respect to the graphical representation of the content. Yet alternatively, displaying the member network at a prominence level higher than the initial prominence level with respect to the graphical representation of the content further comprising simultaneously displaying the graphical representation of the content in a smaller size compared to a size of the graphical representation of the content before receiving the user input and displaying the graphical representation of the first member of the user's network in a larger size compared to a size of the graphical representation of the first member of the user's network before receiving the user input.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example block diagram representing functioning of a content sharing system disclosed herein.

FIG. 2 illustrates an example illustration of a graphical user interface that may be presented by the content sharing system disclosed herein.

FIG. 3 represents an alternative implementation of graphical user interface provided by the content sharing system disclosed herein.

FIG. 4 illustrates an alternative view of a graphical user interface presented by the content sharing system disclosed herein.

FIG. 5 illustrates an alternative graphical user interface that allows a user to share, lend, or borrow resources from other network members.

FIG. 6 illustrates an example flowchart with operations for lending resources from one user to another user.

FIG. 7 illustrates an example flowchart with operations for gifting a resource from one user to another user.

FIG. 8 illustrates an example flowchart with operations for providing collaboration between various users in a network.

FIG. 9 illustrates an example flowchart for sharing content between users even when the users are not connected to a network.

FIG. 10 illustrates an example computing system that can be used to implement the content sharing system disclosed herein.

FIG. 11 illustrates an example mobile computing device that can be used to implement one or more components of the content sharing system disclosed herein.

### DETAILED DESCRIPTION

Activities related to information creation, management, communication and consumption are important components of modern life and economies. Users participate in such activities using a number of devices such as a desktop computer, a laptop computer, mobile devices including smartphone, tablet devices, etc. However, in spite of the proliferation of the mobile devices, they are used primarily for content consumption. For example, other than generating and creating text message, e-mails, simple documents, mobile devices are mostly used for consumption of media. Furthermore, the most common action that users take upon consuming content is to save the content or to share the content with other users. This is particularly common in cases where content is media such as pictures, drawings, audio content, audiovisual content, etc.

There are a number of problems in sharing content with other users using mobile devices and in particular sharing media content with other users. Typically, users have to follow a number of steps to save the content and/or to share the content with other users. For example, after creating a media content, a user saves the content to the local memory such as hard drive, etc. Subsequently, the user opens a communication tool such as a texting application, an e-mail application, etc., initiates an outgoing communication such as an e-mail, selects a destination address of the recipient, such as the recipient's e-mail address, SMS number, etc., and attaches the saved media content to an outgoing communication. Generally, the steps taken by the user are not uniform across various systems. Thus, a user may initiate an outgoing communication in some cases simply by clicking on a link, whereas in other cases, the user may have to provide one or more inputs, such as the recipient's address, heading, etc. Furthermore, in such a case, the user sending the content may not be aware of the preferred mode of communication for the recipient. Thus, for example, a recipient may be interested in receiving communications via email, but the sender, without knowledge of such preference, may use an SMS text message to send the communication.

A content sharing method and system disclosed herein allows a user to share content with other users using a simple one step. In one implementation, such simple one step used to share the content may be swiping the content to a representation of the recipient. For example, using this method, a photograph can be shared with a recipient by placing a finger on the photograph and swiping the finger towards an image of the recipient. Alternatively, such swiping gesture can be accomplished using a mouse. Yet alternatively, other input from a user can be used to share the content. For example, a user can double click on the content and follow it with a double click on the representation of a particular recipient to share the content with that particular recipient. In another example implementation, the user can simultaneously put one finger on the content and another finger on the representation of a particular recipient to share the content with that particular recipient. Yet alternatively, the user may put one finger on the content and another finger on the representation of a particular recipient and use a pinching gesture to share the content with that particular recipient.

In yet alternative implementation, the gesture or input that is required to select and share content with a recipient depends on the type of content. For example, if the content was a user created content, a swiping gesture may be sufficient. On the other hand, if the content is on a webpage, such as a picture on a webpage, a double tap on the content selects the content and subsequently, another double tap on a representation of the recipient shares the selected content with that recipient. Alternatively, a swiping gesture with only one finger may be enough to select a user created content whereas a swiping gesture with two fingers may be required for a non-user generated content, such as content from a website displayed to the user, content from a folder on the computer where such folder is displayed to the user, etc.

The content may be any other type of content or a representation of such content on a graphical user interface (GUI). For example, a thumbnail on the GUI may be used to represent a video file that to be shared by a user. For example, such content may be a user generated content, such as a drawing, a piece of content derived from another source such as a website, etc. Another thumbnail or image of a recipient may represent the recipient of the content. In such a case, a user may simply put his finger (or mouse cursor) on the thumbnail of the content and use a swiping gesture from the thumbnail of the content to the thumbnail of the recipient to share the content with the recipient. Alternatively, the image representing the recipient may also represent a group of recipients, an organization, a company, etc.

In one implementation, the content sharing system disclosed herein allows sharing of content with one recipient or a group of recipients such that each of the recipients receive the content through their preferred mode of communication. Thus, if recipient A prefers receiving content via e-mail the swiping of content towards the image of recipient A results in the recipient A getting an email with the content. On the other hand if a recipient B prefers receiving content via SMS the swiping of content towards the image of recipient B results in the recipient A getting an SMS with the content. The content sharing system allows recipients to specify their preferred mode for receiving content. For example, a recipient C may also select receiving content via more than one mode, thus receiving both and email and an SMS with the content.

Such sharing of content using swiping gesture is particularly useful for users that are not savvy with their use of computers, smartphones, tablets, other mobile devices, etc. For example, children are very visual in their perception and functioning. Thus, a child that is not yet proficient in typing, using apps, etc., can use such swiping gestures to share pictures, drawings, etc., with other members of the child's family. In such a case, the child's parents or teachers may be responsible to set up a network of recipients for the child. For example, a network including parents, siblings, grand parents, other relatives, neighbors' kids, etc., may be created by the parent of a child.

In one implementation of the content sharing system, each member of the network of users may be displayed on a GUI that also displays the content to be shared. For example, a column of thumbnails to the left or right of the content provides thumbnails for various members of the user. Alternatively, the collection of thumbnails may encircle the content. Yet alternatively, the thumbnails may be provided only at the top of the content, at the bottom of the content, etc. An implementation of the content sharing system also allows the list of network members displayed on the GUI to be dynamically updated. Thus, for example, only those members that are active over a predetermined time period are displayed around the content for a given user. Alternatively, only the thumbnails for the network members that have communicated with the user over a predetermined period may be displayed in proximity to the content.

An implementation of the content sharing system disclosed herein also allows users to create their own content and share the content with other users. For example, a first user can create a drawing using finger strokes and use the swiping gesture to communicate the drawing to a second user. Subsequently, the second user may view the drawings in a GUI, make changes to the drawing, and use the swiping feature to communicate the drawing back to the first user. Furthermore, the system also allows a user to combine content of various types, such as combining a drawing with an audio file, a visual file, etc., and communicate the combined file to another user by using the swiping gesture. Yet alternatively, a bundle of documents can be combined together. Thus, a first user, such as a child, can make a drawing of a tree and send it a friend or another recipient in the network of the child. Subsequently, the recipient can add a bird in the tree and send it to a third recipient, who can add a sound recording to the bird's drawing and send the combined creative back to the first user. Such collaborative content creation can be shared amongst a network of users such as, for example, a number of children in a school class, members of a family, etc.

Another alternative implementation of the content sharing system allows a number of users to share one or more capabilities with other users in their network. Thus, for example, a number of students in a classroom may share one or more coloring resources that allow them to make various additions to their paintings, etc. In such an implementation, the coloring resource may a coloring pencil that can be in the toolbox of a painting application. For example, such a coloring pencil can be selected by a user by touching an icon for the coloring pencil using a finger, mouse click, etc. In such an implementation, when a user has a coloring pencil in his or her toolbox, he can use it to make additions his painting or other content. A user having a coloring pencil in the toolbox can also swipe the coloring pencil to a thumbnail of a member in the network to give the pencil to that member.

For example, if John and Mary are part of a kindergarten (KG) class where all the kids in the class are in a shared network and connected, John and Mary can lend/borrow various resources from each other. Thus, if John has earned or purchased a silver color pencil and Mary does not have a silver color pencil, John can lend it to Mary. To lend the pencil, John can simply put his finger on an icon representing the silver color pencil and swipe it towards the thumbnail representing Mary to lend the silver color pencil to Mary. In one implementation, such lending of resources is allowed only to network members that are in the vicinity of a user. Thus, a global positioning system (GPS) provides input to the content sharing system about other users that are located within a predetermined distance of any given user. In such an implementation, the thumbnails of the nearby users are illustrated by a color, brightness, or other features that are different than that of the other users that are not in the vicinity. Furthermore, if a user swipes a resource to a user that is not in such vicinity, the resource is not transferred to the other user, in which case, the user lending the resource may get a message.

In one implementation, the resources that are lent to other users may be lent only for a limited period of time. For example, when used for a network of children in a classroom, a resource that is lent by John to Mary is automatically returned to John at the end of a class period. On the other hand, the users are allowed to determine the time period of such lending and borrowing of the resources.

The content sharing system allows sharing of content among users that may be selected based on various predetermined criteria. For example, in one implementation, a manager or an administrator of the network selects the users that can participate in the network. Such an implementation may be used in a school classroom, where a teacher creates a network of children in the classroom. Alternatively, a super user or an administrative user for an account may approve the network of users. As an example, for a minor user, a parent or an elder in the family may be designated as the administrator of the account, in which case addition of any new user to the network is approved by and setup by the parent. As a result, the parents can be assured of the safety of and communication to and from their children using the content sharing network.

In an alternative implementation of the content sharing system, a service provider, such as a printing facility, a restaurant, a school, etc., may be made a member of the network. As a result, the users are also able to share the content with these service providers. For example, if a printing facility was included as user in a network, a user can simply drag and drop a painting to an icon of the printing facility. In this case, the printing facility generates a physical output, such as a printout of the painting. Another example of such a service provider is a school facility, in which case, the content created by the pupils can be shared with the school using the swiping feature.

The content sharing system also allows users to share content when the devices used to create or view the content are not connected to a network. For example, for children on a hiking trip, their teacher may invite them to draw paintings of the nature. If there is no wireless connection for the devices, a student can still share a drawing with a recipient using the swiping feature. In this case, the content is queued to be shared with the recipient when the network connectivity is restored.

Yet alternatively, the content sharing system also monitors the activity of the users on the network. For example, if for a network of users where the users are all family members and close relatives, the system monitors the level of interaction between various members of the network. The system may further analyze the level of activity to evaluate the health of a relationship between various members of the network.

The content sharing system disclosed herein makes it easier for users to send content across various technologies. Specifically, the content sharing system makes such content sharing uniform such that a user does not have to use different method for different technologies. Thus, for example, sharing user generated content via an e-mail is substantially the same as sharing a content from a website using a text message, etc. Furthermore, the content sharing is also substantially similar across various types of content. Thus, a user can use substantially similar gestures or other inputs to share audio content, video content, text content, etc., using a smartphone, a computer, a tablet, etc.

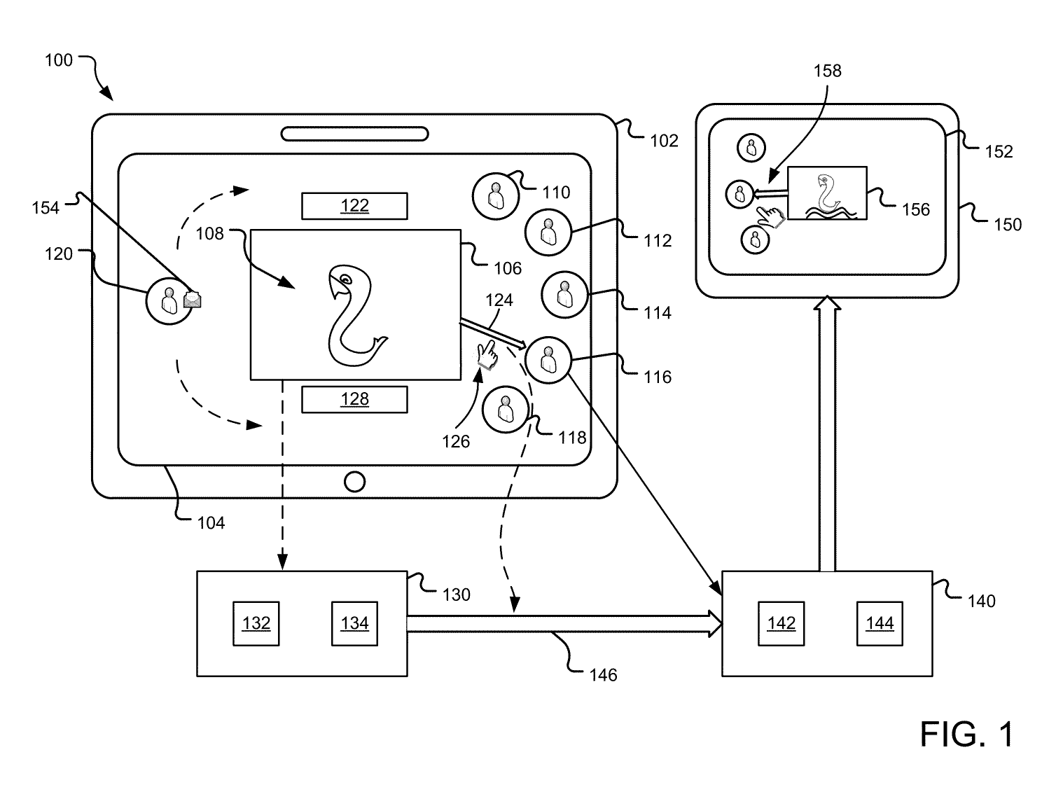

Reference will now be made in detail to implementations of the content sharing system as illustrated in the accompanying drawings and the following detailed description. Specifically, FIG. 1 represents an example block diagram representing functioning of a content sharing system 100 disclosed herein. The content sharing system is illustrated using a tablet 102 that may be used by a user to create, modify, and share content with various users. In one implementation, the user may initiate the use of the content sharing system 100 by activating an application or other software that is stored on the memory of the tablet 102. Once the user initiate the application, a graphical user interface (GUI) 104 is presented to the user. The GUI 104 may provide various icons, usable areas, drop down choices, etc., that can be selected by a user using a touch of a finger. Alternatively, the user can also select one or ore of the options provided by the GUI 104 using a click of a mouse or other input device.

In one implementation, the GUI 104 allows the user to create content in the form of free style drawings in a working area 106. For example, the user can select a drawing resource from a palette 128 and use the resource to create paintings, drawings, etc., in the working area 106. An implementation of the palette 128 displays various drawings resources that are visually easy for a user to select. For example, the palette 128 may disclose a series of colors, each representing a coloring pen and a child can select one of the coloring pen by touching one of such colors. Subsequently, the child can use her or his finger to make strokes within the working area 106 to create a painting. An example of such a drawing 108 is illustrated in FIG. 1.

The GUI 104 also includes a number of other thumbnails 110-120 where each of such thumbnails 110-120 represents a member within the network of the user that is using the GUI 104. While FIG. 1 illustrates the GUI 104 as having only six members within the network a different number of users may be included in an alternative network. As an illustration, if the user is a child, the network members 110-120 may represent various members of his or her family and friends. Thus, the network member 110 may represent mother, the network member 112 may represent father, etc. In one implementation, actual pictures of the members may be used to illustrate the thumbnails 110-120. Alternatively, caricatures or other representation may be used to represent the members of the network. Yet alternatively, one of the thumbnails may also represent a group of members. Thus, for example, the thumbnail 118 may represent a group of members in the network.

Once the user has created a drawing within the working area 106, the user can also add other content to the drawing, such as a note, an audio content, a video content, etc. In one implementation, the GUI 104 also includes a content listing 122 that provides a list of content that a user can select to add to the working area 106. Thus, for example, a sound clip 124 from the content listing 122 can be added to the working area. Thus, the user can create a content that is rich with various multimedia content, such as a storybook, etc. Specifically, the content from the content listing 122 can be added to the working area 106 by simply touching an icon or a thumbnail representing the content and dragging it to the working area 106.

In one implementation, the content sharing system 100 saves the content created by the user automatically to a storage area 130. For example, such a storage area 130 may be a volatile memory, a non-volatile memory, etc. In the example illustrated in FIG. 1, the storage area 130 is illustrated to comprise a volatile memory 132 and a non-volatile memory 134. As the user is creating content within the working area 106, the system 100 automatically shares the content to the volatile memory 132 at end of every pre-determined period, such as 1 ms, etc. Furthermore, the content saved in the volatile memory 132 may also be saved in the non-volatile memory 134 periodically.

Once a user has created a content, such as a drawing, etc., in the working area 106, the user can simply share the content with one or more of the other users in the network by simply selecting the working area 106 and by using a swiping motion towards one of the thumbnails 110-120 representing a network member. For example, the use can use a finger, a touch-pen, a mouse pointer, etc., to touch the working area 106 and swipe it to one of the thumbnails. Such a sharing of content with the network member represented by the thumbnail 116 is represented in FIG. 1. As illustrated, a swiping motion 124 by the user using a finger 126 is used to share the content from the working area 106 with network member 116.

As a result of the swiping motion 126, the content from the storage area 130 is moved to a storage area 140, wherein the storage area 140 corresponds to a device 150 used by the network member 116. The storage area 140 also includes a volatile memory 142 and a non-volatile memory 144. The user device 150 may be a computing device or a mobile device, such as a smartphone, a mobile device, a tablet device, etc. The content sharing system 100 determines the destination address where the content from the working area 106 is sent based on the settings for the network member 116. For example, the network member 116 may have provided that anytime a user shares content, such content shall be sent to the network member 116 via an email. In such a case, in response to a swiping action 124, the content from the storage area 130 is sent to the storage area 140 via an email communication 146. Similarly, the network member 116 may also provide other manners of preferred communication, such as text message, update to an account on a social networking website, etc. Yet alternatively, multiple preferred communication modes may be provided, in which case, the swiping of content towards the network member 116 may result is multiple communications with the network member, by email, by SMS, by social networking website update, etc.

Once the network member 116 receives the content in the storage area 140, it is available for view and modification by the network member 116 on the user device 150. For example, the user device 150 may also have a GUI 152 similar to the GUI 104 and anytime any content is sent to the network member 116, an icon or a message is shown on such GUI 152 to illustrate an incoming communication from another network member. In the example illustrated in FIG. 1, such an incoming communication from the network member 120 is illustrated by a mail icon 154 next to the thumbnail representing the network member 120. In an alternative implementation, a communication from a network member may also be represented by changing the color of the thumbnail representing the network member, by assigning a particular movement to the thumbnail representing the network member, etc.

Once the network member 116 receives the content, the network member 116 can also select to view or modify the received content. In such a case, the received content is displayed in a working area 156 of the GUI 152. Once the changes are made to the content in the working area 156, the content can be shared with other users of the network, including the member that initially sent the content, using a swiping motion 158. Thus, the content sharing system 100 allows collaborative development of content between various members of the network. Note that while the working area 106 as illustrated in FIG. 1 is used for collaboratively creating a painting or an audio-visual content, in an alternate implementation, such an area may also be used for creating other content such as written content, spreadsheets, presentations, etc. Thus, for example, two more colleagues at a business may share a document that they are collaboratively developing using the content sharing system 100.

The content sharing system 100 is configures to allow only a person with administrative authority to add members to a user's network. Thus, when a pupil is using the GUI 104 in a school classroom, only the teacher may be allowed to add a member to the network of the pupil. Similarly, if a child is using the GUI 104, only a parent or the parents of the child may be allowed to add a member to the child's network. Providing such administrative, or super user, ensures that the use of the content sharing network is safe for a minor.

While the GUI 104 is illustrated to display various network members 110-120 at a substantially similar distance from the working area 106, in an alternative implementation, the network members 110-120 may be displayed at a distance depending on some other parameter. For example, the network members 110-120 that are more active in communicating with the user may be displayed closer to the working area, whereas the network members 110-120 that are less active are displayed further away from the working area 106, at the edge of the GUI 104, etc. In yet alternative implementation, the interactions between two members is monitored and analyzed over time to determine a relationship health score for each pair of network members. If the relationship health score is high for a given network member, that network member is displayed closer to the working area 106 compared to another network member with a lower relationship health score.

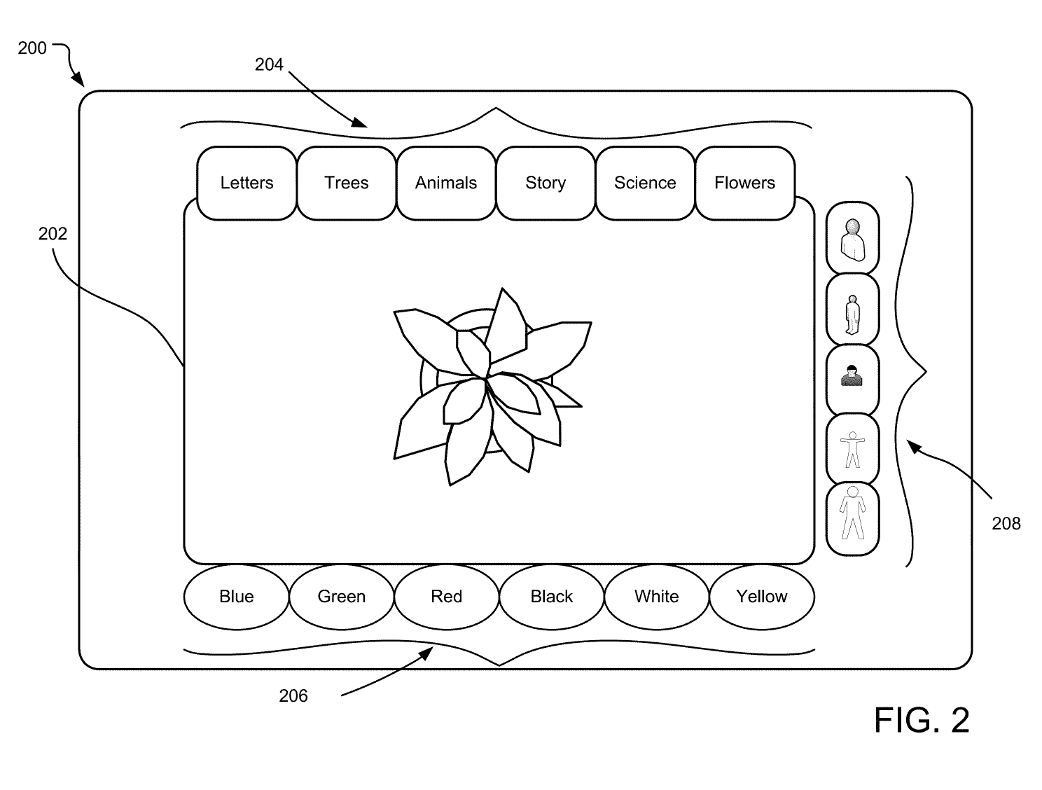

FIG. 2 illustrates an example illustration of a graphical user interface 200 that may be presented by the content sharing system disclosed herein. The GUI 200 provides a working canvas area 202 and a number of templates 204 to the user. A user can select one of the templates 204 and draft the template to the canvas area 202 to create content. Additionally, the GUI 200 also provides a number of color options 206 that can be selected by touching one of the color options 206 using a finger, a mouse pointer, a touch-pen, etc., and drawing on the canvas area. While FIG. 2 only illustrates a limited number of templates 204 and color options 206, a user can scroll to the right or to the left to find other templates and colors. Furthermore, the templates 204 and the colors 206 are automatically adjusted based on the past use by the user. Thus, if a user has used the yellow color more often, the GUI 200 adjusts the color options 206 to move the yellow color to the center, etc.

The GUI 200 also includes a number of thumbnails or icons representing members 208 of the user's network. Specifically, the network members 208 are represented on the side of the canvas area 202 such that the user can swipe the canvas area to one of the network members using a swiping gesture. Such a swiping gesture may be accomplished by selecting the canvas area using a finger, a mouse pointer, a touch-pen, etc. The icons representing the network members 208 may also include one or more icons that represent a group of network members, such as all students in a classroom, all kids in a neighborhood, etc.

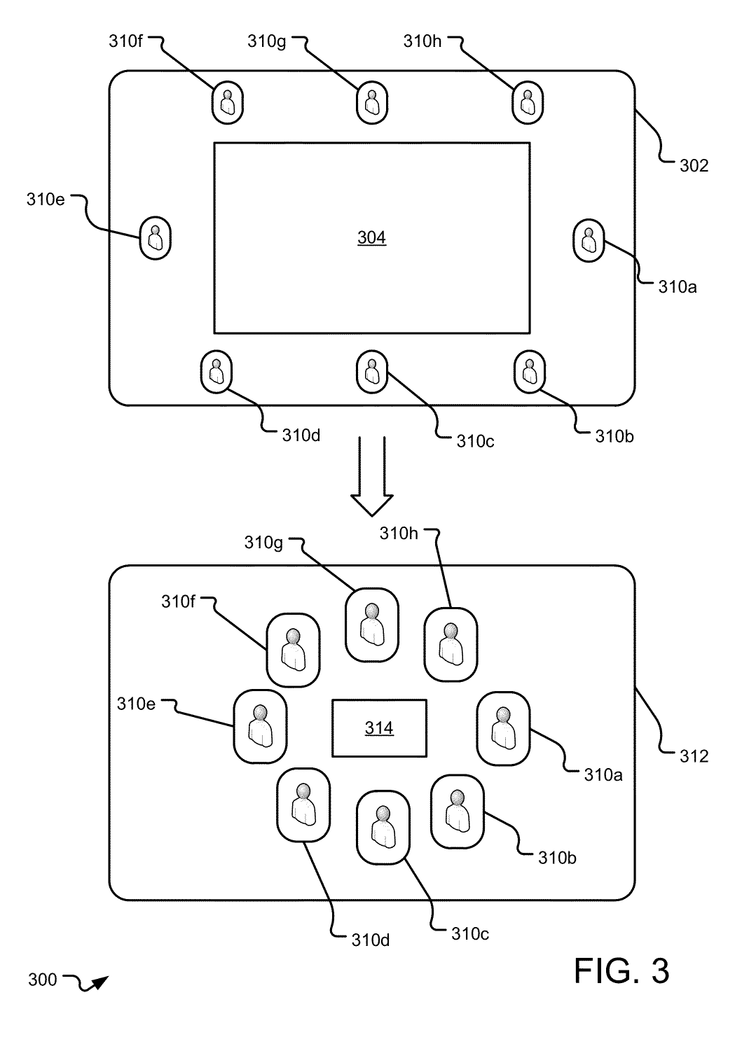

FIG. 3 represents an alternative implementation of graphical user interface 300 provided by the content sharing system disclosed herein. Specifically, the GUI 300 illustrates an implementation that allows a user to easily share content with other members of the user's network. A view 302 of the GUI 300 illustrates a working area 304, such as a canvas area, enlarged in the middle of the GUI 300 with smaller icons representing network members 310a-310h. The GUI 302 represents the icons representing the network members 310a-310h at an initial prominence level with respect to the content 304, such that the smaller icons are less prominent on the GUI. When the user is ready to share the content with one of the network members 310a-310h, the user can shrink the size of the working area 304. For example, the user can shrink the size of the working area 304 by using pinching actions using two fingers. Alternatively, the user can select an edge of the working area using a mouse pointer, a touch pen, etc., and drag the mouse pointer or the touch pen to shrink the size of the working area.

In an implementation of the GUI 300, in response to the input from the user to shrink the size of the working area 304, the GUI enlarges the icons representing the network members 310a-310h and brings them closer in towards the working area. This is further illustrated by the alternative view 312 of the GUI. Specifically, as shown in the alternative view 312, when the user instructs the GUI to shrink the size of the working area 304, it is reduced to a smaller working area 314. Furthermore, the size of each of the icons representing the network members 310a-130b is increased and such icons are displayed in closer vicinity to the working area. The GUI 312 represents the icons representing the network members 310a-310h at a higher prominence level with respect to the content 314, such that the larger icons are more prominent on the GUI. In other words the prominence level of the network members 310a-310h in the GUI 312 is higher than the prominence level of the network members 310a-310h in the GUI 302.

Such change in the displaying of the working area 304 to the working area 314 and the closed displaying of the icons representing the network members 310a-310h allows the user to more easily view the network members. Furthermore, it is easier for the user to use the swiping action to share the content of the working area with one or more of the network members. Thus, because the icons representing the network members are clearly distinct from each other, the user can easily select the content of the working area 314 and swipe it towards one of the icons 310a-310h using a finger, a mouse pointer, etc. Subsequently, if the user expands the size of the working area 314, the icons representing the network members 310a-310h is reduced and they are moved away from the working area 314.

In an alternative implementation, the instructions to reduce the size of the working area 304 may only reduce the size of the icons representing the network members 310a-310h or only bring them into the vicinity of the working area 304. Furthermore, the change in the size of the icons representing the network members 310a-310h and their move towards the working area 304 or away from the working area 304 may be linearly related. Thus, the bigger the shrinking of the working area, larger the increase in the size of the icons representing the network members 310a-310h, etc. Other relationships such as step relationship, etc., may also be used.

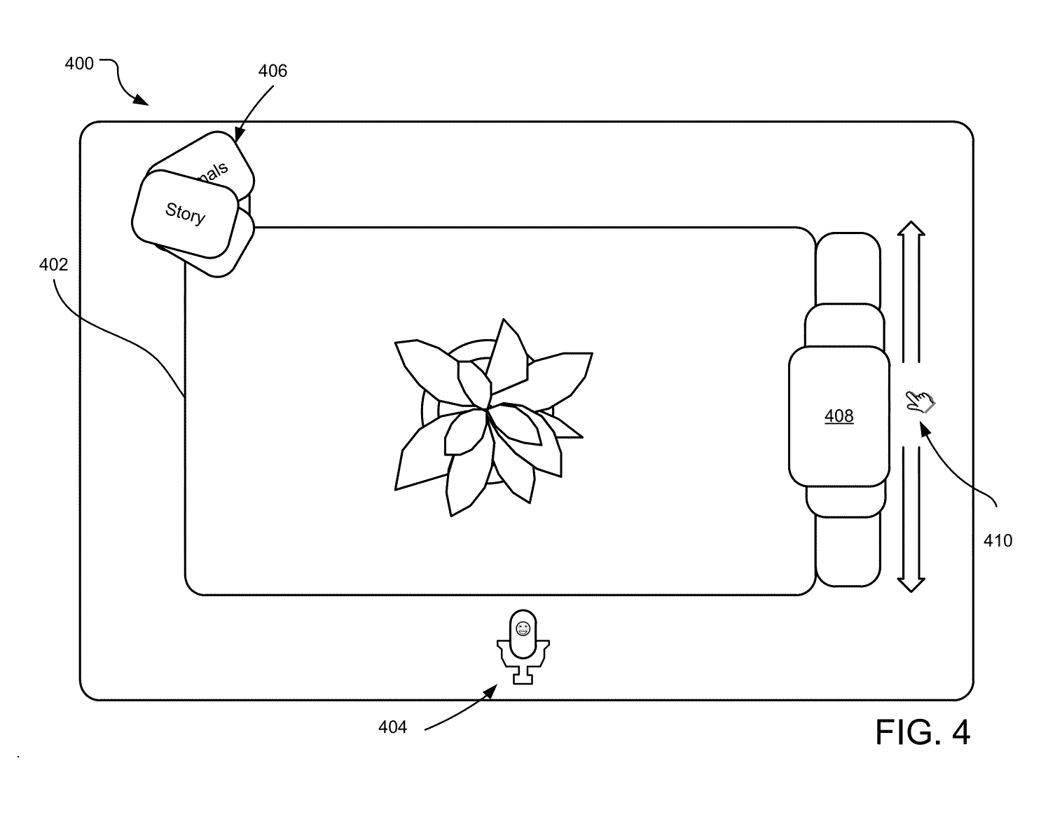

FIG. 4 illustrates an alternative view of a graphical user interface 400 presented by the content sharing system disclosed herein. The GUI 400 presents the canvas or working area 402 substantially in the center of the GUI 400. The GUI 400 also includes a multimedia activation control 406 at the bottom of the working area 402. The activation control 406 can be used to activate one or more multimedia components that may be embedded within the canvas area 402. The GUI 400 displays various templates 406 to the top left of the working area 402. A user can get a full view of each of the individual of the templates 406 by touching the templates 406 bunched together on the top left, by hovering a mouse pointer over the templates 406, etc.

Furthermore, the GUI 400 displays the network members 408 to the right side of the working area 402 such that when a user moves a finger 410, a mouse pointer, etc., to the top of a listing of the network members 408, an icon representing a network member substantially beneath the finger 408 is enlarged. As the user moves the finger 410, a mouse pointer, etc., up and down, a different network member icon is expanded and brought to the front for an easier selection by a user.

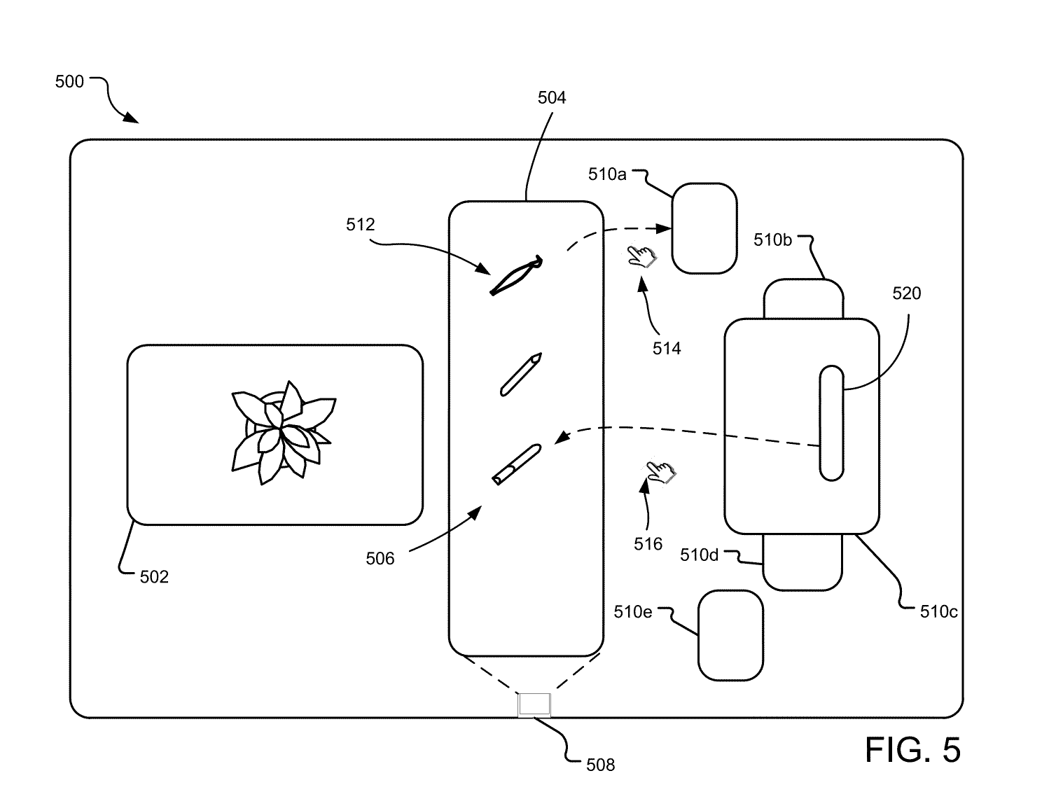

FIG. 5 illustrates an alternative graphical user interface 500 that allows a user to share, lend, or borrow resources or resources from and with other network members. Specifically the GUI 500 displays a working area 502 that can be used by a user to generate content. The GUI 500 also displays a toolbox 504 representing a number of resources 506 to generate content, such as a pencil, a coloring brush, an eraser, etc. In one implementation, the user can invoke the display of the toolbox by selecting a particular option on the GUI 500, such as the toolbox icon 508 displayed on the bottom of the GUI 500. In an alternative implementation, such resource or resource may be digital resources, such as a digital content, a piece of software, etc.

The GUI 500 allows the user to lend one or more of the resources from the toolbox 504 to other network members 510a-510e. For example, if the user wants to lend a paintbrush resource 512 to the network member 510a, the user can select the paintbrush resource using a finger, a mouse pointer, etc., and share the resource with the network member 510a using a swiping gesture 514 as illustrated in FIG. 5. In one implementation of the content sharing system, a user is allowed to share a resource with a network member only if the network member is in the vicinity of the user. Thus, if the user and the network member 510a are both in the same classroom, the user is allowed to share the paintbrush resource 512 with the network member 510a. The content sharing system uses GPS modules located within the devices used by the user and by the network member 510a to determine that the users are in the vicinity of each other. For example, anytime the GUI 500 receives an instruction from the user, as a result of a swiping motion 514, etc., to share a resource or to lend a resource with another network member, the GUI 500 instructs the GPS module within the user device to determine whether the network member 510a is within a predetermined distance. If the network member 510a is not within such predetermined distance, the GUI 500 provides a message to the user that such lending or sharing of the resource is not allowed at this time.

Such lending and borrowing of resources that can be used to generate content allows the content sharing system to generate feel of a community within various users. For example, if the users are a number of children in a classroom, each of the children can lend and/or borrow coloring pens, pencils, erasures, etc., among each other, thus generating a feel of a responsible citizen in the classroom. When a resource is lent from a user to a borrower, the lender is not able to use the resource anymore, providing the children the feeling of a real lending and borrowing operation. Such lent resource may be represented in the toolbox 504 by a disabled icon that is displayed in lighter color, at the bottom of the toolbox 504, etc.

Once a resource is lent to another network member, the content sharing system periodically determines whether the borrowing network member is still within a vicinity of the lending user. If it is determined that the lending user and the borrowing user are not within vicinity of each other, the content sharing system discontinues the borrowing user's privilege to use the borrowed resource. Thus, for children in a classroom sharing painting resources, when the children go away from the classroom, the resources are returned back to the lender. In an alternative implementation, the content sharing system is further configured to measure the time for which a resource can be lent to another user or shared with another user. This allows for user to borrow a resource for only a limited period of time, after which the resource is returned to the lender.

Furthermore, the GUI 500 also allows the user to generate a request to borrow a resource from a network member. For example, if the user of the toolbox 504 does not have a chalk of a certain color, the user can peruse the toolboxes of the network members 510a-510e. The user can do so by hovering a finger, a mouse pointer, etc., over the icons representing the network members 510a-510e. The GUI 500 may be configured such that anytime the toolbox 504 is open, such selection of one of the network members 510a-510e also shows the resources available to such network member. Thus, as illustrated in FIG. 5, when the user has selected network member 510c, a toolbox 520 with various resources (not shown) is displayed on the GUI 500. Subsequently, the user can drag 516 a particular resource from the toolbox 520 to the toolbox 504. In such a case, a request for that particular resource is sent to the network member 510c. If the network member 510c approves such a request, that particular resource is enabled in the toolbox 504 and a confirmation message is received at the GUI 500.

Yet alternatively, the GUI 500 may also allow the user to gift one of the resources from the toolbox 504 to a network member. In one implementation, such gifting of a resource is accomplished by a swiping motion similar to the swiping motion 514 used for lending a tool. Thus, for example, when a user completes the swiping motion 514, the GUI asks the user whether the motion 514 was meant for lending of the resource 512 or for gifting of the resource 512. If the user indicates that the resource 512 is being gifted, the icon for that resource 512 is permanently removed from the toolbox 504.

In an alternative implementation, sharing a resource may also be based on other criteria, such as reward points earned by a user in the network, etc. For example, a group administrator may provide collaboration reward points to a user based on the users participation in various collaborative projects. In such a case, after accumulating reward points above a threshold, the user may be able to borrow a resource from the administrator. Alternatively, the user may also be able to purchase such a resource from the administrator or other users on the network. Yet alternatively, other modes of borrowing and lending, such as based on money, credit cards attached to the users' accounts, etc., may also be used for borrowing, lending, gifting, etc.

In yet alternative implementation, a resource may be shared by a number of users in a network. Thus for example, if a silver color pencil is a shared resource among a number of users in a network, the silver color pencil will be available to only one user of the network at any given time. In such an implementation, each user may be able to check out the silver color pencil for a limited amount of time, reserve the silver color pencil for a limited amount of time, etc. The sharing of such shared resource or resource may be based on geographic restrictions such that users can only use such a shared resource when they are in certain geographic area, such as a school campus, a company conference room, etc. Alternatively, the use of such a shared resource may be based on user collaboration, such that only those users that have collaborated on a project are able to borrow and use such a shared resource.

An alternative implementation of the content sharing system also allows sharing of tools and resources using different gestures or user inputs. Thus, for example, when a user is lending a resource to another user, the user may use swipe using one finger. On the other hand, to gift a resource or resource, a swiping gesture with two fingers is used. Alternatively, one-click on a resource is used to lend it to a user and two-click tap is used for gifting the resource to user. Other combination of gestures or inputs may also be used.

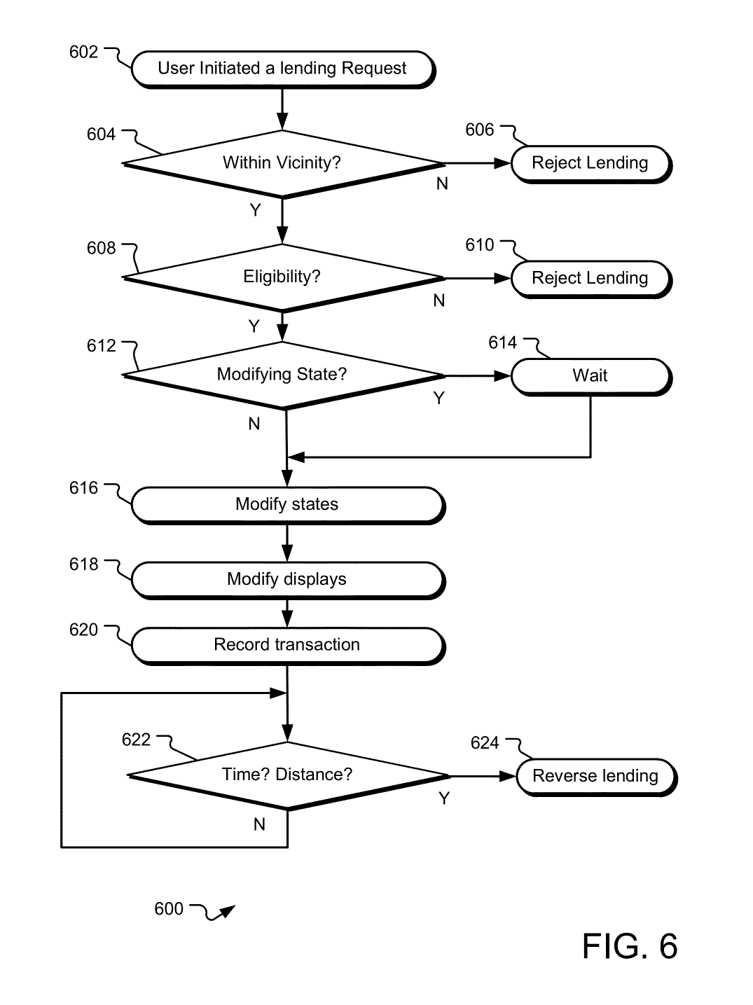

FIG. 6 illustrates an example flowchart 600 with operations for lending tools from one user to another user of the content sharing network disclosed herein. The operations of the flowchart 600 may be initiated when a user initiate a landing operation on a GUI. Specifically, an operation 602 receives a lending request from a user to lend a resource to another network member. Such lending request may be received, for example, when a user swipes a resource from a toolbox displayed in the user's GUI towards an icon or thumbnail of a network member. Alternatively, such lending request may also be initiated in response to a borrowing request from another network member. In such a case, an affirmative response to the borrowing request will generate the lending request.

In response to the request for lending a tool, a determination operation 604 determines if the lending user and the receiving network member are in vicinity of each other. If it is determined that the lending user and the receiving network member are not within such vicinity, an operation 606 sends a message to the lending user that the resource cannot be lent at this time. Subsequently, another determination operation 608 determines if the lending user is eligible to lend the resource and if the receiving network member is eligible to receive the tool. For example, the determination operation 608 determines whether the lending use in fact has the resource and whether the lending user has the ownership of the tool. Thus, for example, if the lending user is in fact borrowing the resource from a third party, the lending user cannot lend such resource to someone else. Similarly, if the lending user has already lent the resource to someone else, again the lending user cannot lend the resource multiple times. If the determination operation 608 determines that the requested lending is not an eligible operation, an operation 610 informs the lending user of the failure of the lending request and provides a message with the reasons for the failure.

Subsequently, another determination operation 612 determines if the lending user is in a modifying state. For example, if the lending user is currently using the resource for modifying content, the determination operation 612 passes the control to a waiting operation 614. Once the waiting operation determines that the modifying state is completed, the control is passes to the operation 616. The operation 616 is a modification operation that modifies the states of the lending user and the borrowing user. Thus, for example, if a pencil resource is lent from the lending user to the borrowing user, the modifying operation 616 modifies the lending user state to a state where the lending user does not have the pencil resource anymore, whereas the state of the borrowing user is modified to display it having the pencil resource in its toolbox.

Subsequently, another modification operation 618 also modifies the displays for the lending user and the borrowing user. Thus, the lent resource is removed from the toolbox displayed on the lending user's GUI and it is added to a toolbox displayed on the borrowing user's GUI. A recording operation 620 records the collaboration between the lending user and the borrowing user.

At this point the borrowing user is able to use the lent resource in creating content, modifying content, etc. Another determination operation 622 monitors the changes in the time elapsed since the resource was borrowed, the distance between the lending user and the borrowing user, etc. For example, the determination operation 622 compares the distance between the lending user and the borrowing user on a periodic basis. If it is determined that the distance is above a predetermined threshold, indicating that the lending user and the borrowing user are not within a vicinity of each other, a reversing operation 624 reverses the lending of the tool. As a result, the lent resource is returned back to the lending user and displayed in a toolbox of the lending user. At the same time the reversing operation 624 may also send a message to the borrowing user of the return of the borrowed tool. Similarly, if the determination operation 622 determines that a predetermined amount of time, such as twenty-four hours, etc., has passed since the completion of the lending operation, it notifies the reversing operation to reverse the lending of the tool.

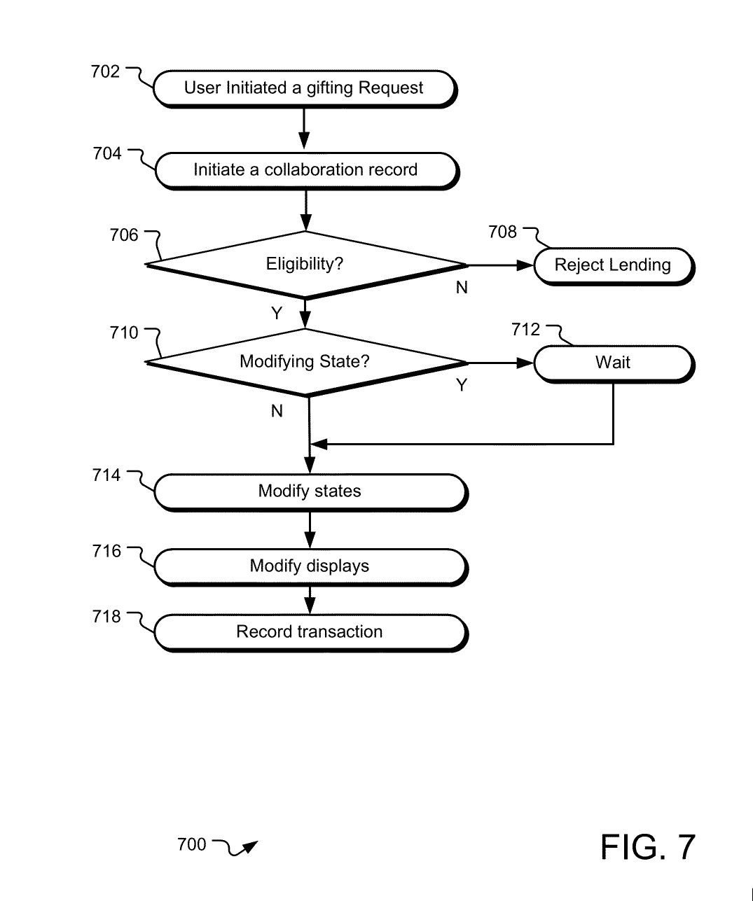

FIG. 7 illustrates an example flowchart 700 with operations for gifting a resource from one user to another user. Various operations of the flowchart 700 are somewhat similar to the operations of the flowchart 600. Specifically, an operation 702 receives a lending request from a user to gift a resource to another network member. Upon receiving the request for gifting of a tool, an initiating operation 704 initiates a collaboration record between the gifting user and the receiving network member. At this state the collaboration record may be marked as a pending record. Subsequently, a determination operation 706 determines if the gifting user is eligible to gift the resource and if the receiving network member is eligible to receive the tool.

If it is determined that the gifting and/or receiving of the resource is not possible, a rejection operation 708 rejects the gifting operation. The rejection operation 708 may also send a notification to the gifting user of the rejection and the reasons thereof. Furthermore, the rejection operation 708 may also annul the collaboration record initiated at operation 704. Subsequently, another determination operation 710 determines if the gifting user is in a modifying state. For example, if the gifting user is currently using the resource for modifying content, the determination operation 710 passes the control to a waiting operation 712. Once the waiting operation 712 determines that the modifying state is completed, the control is passes to an operation 714. The operation 714 is a modification operation that modifies the states of the gifting user and the receiving user. Thus, for example, if a pencil resource is gifted from the gifting user to the receiving user, the modifying operation 714 modifies the gifting user state to a state where the gifting user does not have the pencil resource anymore, whereas the state of the receiving user is modified to display it having the pencil resource in its toolbox.

Subsequently, another modification operation 716 also modifies the displays for the gifting user and the receiving user. Thus, the gifted resource is removed from the toolbox displayed on the gifting user's GUI and it is added to a toolbox displayed on the receiving user's GUI. A recording operation 718 records the collaboration between the gifting user and the receiving user.

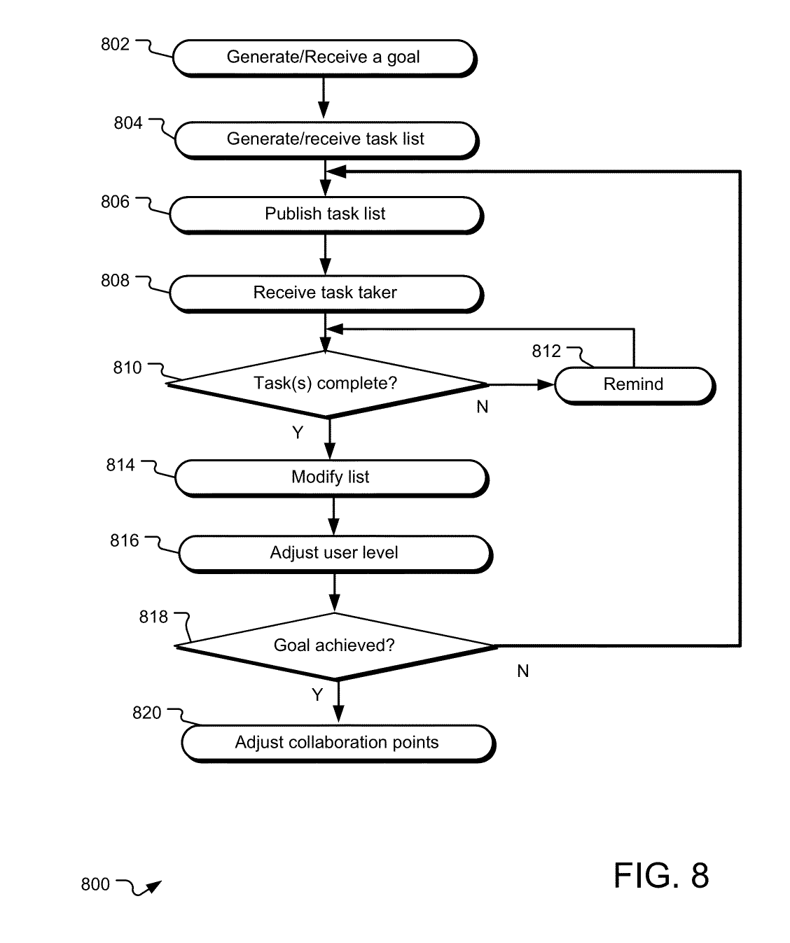

FIG. 8 illustrates an example flowchart 800 with operations for providing collaboration between various users in a network. The operations disclosed in FIG. 8 allow the content sharing system to facilitate conversation between various users of a network. Specifically, these operations allow the users to collaborate over a topic or a particular content. For example, the operations illustrated in FIG. 8 allow various users to work together on a game that includes a number of progressive steps. Alternatively, these operations allow the users to generate content in a collaborative manner, such as for example, between members of a family, pupils in a given classroom, etc.

An operation 802 generates of receives a goal to be achieved by various users in a collaborative manner. Such goal may be, for example, generating a storybook, completing a presentation between business colleagues, etc. Example of such tasks for achieving the goal of creating a storybook may be, for example, creating page 1, adding audio content, creating page 2, etc. Subsequently, another operation 804 generates or receives a task list for achieving the goal. Such task list is published by an operation 806.

Various users in a network may be able to see the task list when then open a GUI of the content sharing system. An operation 808 receives a task taker. For example, for creating a storybook in a classroom, one of the pupils may elect to create the first page of the storybook. In one implementation, only one user is allowed to select a task from the list and once such user has selected a task, other users are not allowed to take on that task. However, in an alternative implementation, more than one users may be allowed to select a particular task.

A monitoring operation 810 monitors the status of the tasks selected by various users. For example, each user can notify the content sharing system that a particular task selected by that user has been completed. If the monitoring operation 810 has not received such notification about a particular task after a predetermined time period, it may generate a reminder to the user at operation 812. If a particular task is completed, an operation 814 modifies the task list. Furthermore, an operation 816 also adjusts user level for the user completing a particular task. By adjusting user levels in response to completion of tasks, users can achieve higher skill levels by participating on a project.

Another determination operation 818 determines if the goal is achieved and if so, an operation 810 adjusts the collaboration points for the various users that contributed in achieving that goal. If the goal is not yet achieved, an updated task list if published so that users may contribute to one or more of the tasks.

The content sharing system also allows for the users to share the content, whether created individually or collaboratively, with other social networks, preferred vendors, etc. For example, the GUI presented to the users may also include icons for preferred vendors, such as preferred photo publishing provider, US postal service, etc. Thus, when content needs to be shared with such preferred vendor, a user can simply send the content to the preferred vendor simply by swiping the content towards such vendor.

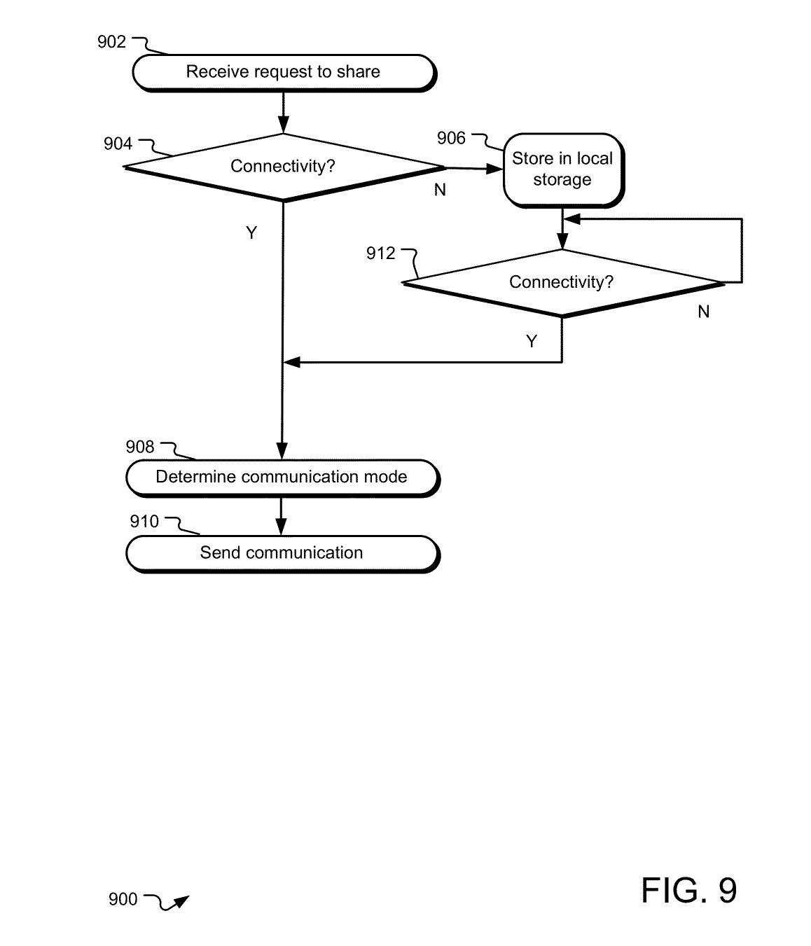

FIG. 9 illustrates an example flowchart 900 for sharing content between users even when the users are not connected to a network. Specifically, a receiving operation 902 receives a request from a user to communicate with another user. For example, such a request may be a request to communicate user generated content, a poking message, a tool, etc. A determination operation 904 determines whether the user device has connectivity or not. For example, if the user is on an airplane generating content using the content sharing system, the user may not have connectivity to a network, in such a case a storing operation 906 stores the content to be shared in a local memory with other metadata such as the identity of the receiver, the mode of communication with the receiver, etc.

If the connectivity is present, a determining operation 908 determines the mode of preferred communication for the receiver. For example, the receiver may prefer getting an e-mail, an SMS, etc. Subsequently, a sending operation 910 sends the outgoing communication to the receiving network member. When the shared content is temporarily stored in local memory, another determination operation 912 checks for the connectivity on a periodic basis and when it is determined that the user device is connected to a network such as the Internet, etc., the control is transferred to operation 908.

Furthermore, the content sharing system also generates the strength of various relationships between various users in a network. For example, if a network is created using members of a family, the content sharing network measures the strength of relationship between two members of the family, such as between a father and a daughter, a grandmother and a grandson, etc. In one implementation, such relationship strength may represent the strength of a bond between two users, as exemplified by their interactions over the network. Examples of the factors used to calculate the strength of relationships are provided below in Table 1.

TABLE 1

| | |
|---|---|
| Extent of | Each interaction holds a different value signifying the |
| Interaction | extent to which two users interact. |
| Balance of | An interaction between User A → User B as a result of a |
| Interaction | User B → User A interaction earns more points than a |
| | standalone interaction between User A and User B. Also a |
| | User A → User B following a pastUser B → User A |
| | interaction earns more points than a standalone interaction |
| | between User A and User B. |
| Frequency of | A short-term increase in the amount of interaction between |
| Interaction | two users results in an increase in the points between the |
| | two users. |
| Length of | The longer is the interaction between two users, the |
| Relationship | stronger is the relation between two users. |

Table I illustrates an example of the allocation of relationship points based on interactions between various users in a network. Specifically, the relationship points depend on the type of activity, such as sharing a user generated content (UGC), gifting of tools or content, lending of resource or content, collaborating on a project or a goal, communicating by other means, such as poking other user, etc.

TABLE 2

| Interaction | Points | |
|---|---|---|
| Sharing | | |
| Sharing UGC (A → B) | 2 | points |
| Sharing UGC (B → A) after at least one (A → B) has | 3 | points |
| happened | | |
| Gifting | | |
| Gifting a tool | 3 | points |
| Collaborating synchronously on a UGC | 4 | points |
| Gifting on a special day (birthday, etc.) | Extra 1 | point |
| Lending | | |
| Lending a resource to someone nearby | 2 | points |
| Lending a resource to someone a user has interacted | 3 | points |
| before | | |
| Collaborating | | |
| Sharing same UGC in both directions | 4 | points |
| Collaborating synchronously on a UGC when in | 5 | points |
| vicinity of each other | | |
| Poking | | |
| Voice communications | ½ | point |

While Table 2 illustrates an example scheme for allocation of relationship points, other methods and scheme for allocation of relationship points may also be used. Furthermore, to keep the value of the relationship values relevant, the content sharing system also provides for decaying of the relationship in absence of interactions. For example, the relationship between two users may be set to decrease by two points per day, where such decrease may be based linear, based on a step function, based on an exponentially decaying function, etc. Also, there may be special occasions that result in decrease of relationship points, such as not communicating with a user on the user's birthday, communicating with another user using adversarial language, etc.

Furthermore, the content sharing system allows for using the length of a relationship in adjusting the strength of a relationship. For example, the relationship point allocation as provided by Table 2 may be adjusted using a multiplication factor that depends on the length of a relationship. Thus, for example, if a relation is less than a week old, the points are multiplied by one, if the relationship is between one and four weeks, the points are multiplied by 1.25, if the relationship is between four and eight weeks, the points are multiplied by 1.50, if the relationship is between eight and twelve weeks, the points are multiplied by one 1.75, etc.

Yet alternatively, the frequency of interactions between the users can also be used to alter the allocation of relationship points. Thus, less than ten interactions results in multiplication factor of one, 10-20 interactions results in multiplication factor of 1.1, 20-30 interactions results in multiplication factor of 1.2, etc. As the time increases, the adjustment to the relationship points is more based on length of relationship compared to the number of interactions. Other factors, such as distance between the users, etc., may also be used to adjust the relationship health score between two users. The relationship score can be used to reward the users in the network. Thus, if an individual user has high relationship scores with other users, such individual user may be given a badge, a special tool, a special recognition on the GUI, etc.

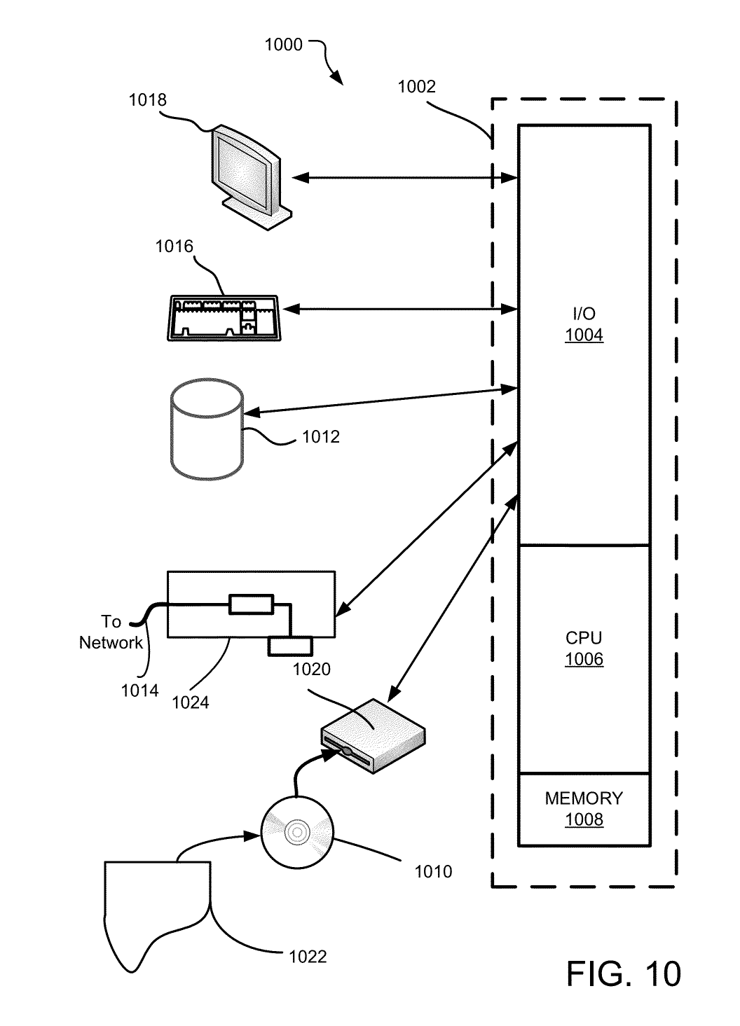

FIG. 10 illustrates an example computing system that can be used to implement one or more components of the content sharing method and system described herein. A general-purpose computer system 1000 is capable of executing a computer program product to execute a computer process. Data and program files may be input to the computer system 1000, which reads the files and executes the programs therein. Some of the elements of a general-purpose computer system 1000 are shown in FIG. 10, wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer such as one or more external computers made available via a cloud computing architecture. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 10 to a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1004, on a disk storage unit 1012, or on the DVD/CD-ROM medium 1010 of such a system 1000, or external storage devices made available via a cloud computing architecture with such computer program products including one or more database management products, web server products, application server products and/or other additional software components. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 1008 or other storage systems, such as disk storage unit 1012 or DVD/CD-ROM medium 1010 and/or other external storage device made available and accessed via a cloud computing architecture. Still further, some or all of the operations for the system for content sharing disclosed herein may be performed by the processor 1002. In addition, one or more functionalities of the system disclosed herein may be generated by the processor 1002 and a user may interact with these GUIs using one or more user-interface devices (e.g., a keyboard 1016 and a display unit 1018) with some of the data in use directly coming from third party websites and other online sources and data stores via methods including but not limited to web services calls and interfaces without explicit user input.

A server hosts the system for content sharing. In an alternate implementation, the server also hosts a website or an application that users visit to access the system for content sharing. Server may be one single server, or a plurality of servers with each such server being a physical server or a virtual machine or a collection of both physical servers and virtual machines. Alternatively, a cloud hosts one or more components of the system for content sharing. The user devices, the server, the cloud, as well as other resources connected to the communications network access one or more of servers for getting access to one or more websites, applications, web service interfaces, etc., that are used in the content sharing system. In one implementation, the server also hosts a search engine that is used by the system for accessing the system for content sharing and to select one or more services used in the content sharing system.

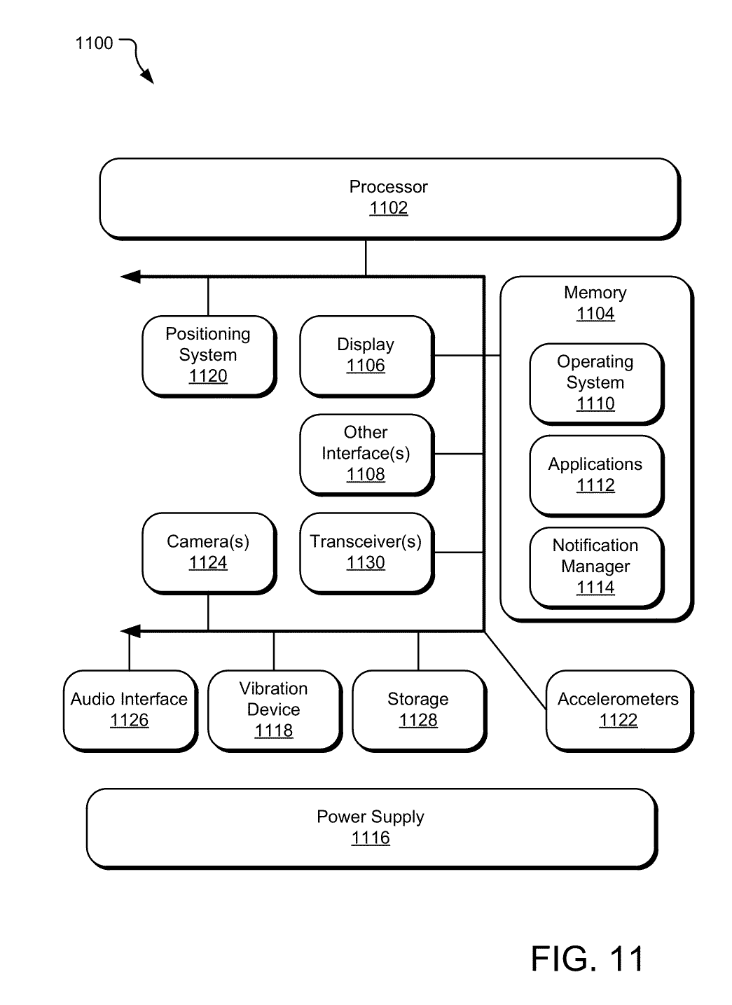

FIG. 11 illustrates an example mobile computing device 1100 that can be used to implement one or more components of the content sharing system disclosed herein. Specifically, the mobile computing device 1100. The mobile device 1100 includes a processor 1102, a memory 1104, a display 1106 (e.g., a touchscreen display), and other interfaces 1108 (e.g., a keyboard). The memory 1104 generally includes both volatile memory (e.g., RAM) and non-volatile memory (e.g., flash memory). An operating system 1110, such as the Microsoft Windows® Phone 7 operating system, resides in the memory 1104 and is executed by the processor 1102, although it should be understood that other operating systems may be employed.

One or more application programs 1112 are loaded in the memory 1104 and executed on the operating system 1110 by the processor 1102. Examples of applications 1112 include without limitation email programs, scheduling programs, personal information managers, Internet browsing programs, multimedia player applications, etc. In one implementation, an content sharing application stored in the memory 1104 may be used to catalog various observations stored on the mobile device 1100, such as e-mail addresses from the e-mail application of the mobile device, the contacts from a contact management application stored on the mobile device 1100, etc. In yet alternate implementation, a client application stored in the memory 1104 of the mobile device 1100 may generate queries using the information stored on the mobile device 1100, receive entity relation information from a server generating relations between various elements, and display updated observations to a user of the mobile device 1100. A notification manager 1114 is also loaded in the memory 1104 and is executed by the processor 1102 to present notifications to the user. For example, when a promotion is triggered and presented to the shopper, the notification manager 1114 can cause the mobile device 1100 to beep or vibrate (via the vibration device 1118) and display the promotion on the display 1106.

The mobile device 1100 includes a power supply 1116, which is powered by one or more batteries or other power sources and which provides power to other components of the mobile device 1100. The power supply 1116 may also be connected to an external power source that overrides or recharges the built-in batteries or other power sources.

The mobile device 1100 includes one or more communication transceivers 1130 to provide network connectivity (e.g., mobile phone network, Wi-Fi®, BlueTooth®, etc.). The mobile device 1100 also includes various other components, such as a positioning system 1120 (e.g., a global positioning satellite transceiver), one or more accelerometers 1122, one or more cameras 1124, an audio interface 1126 (e.g., a microphone, an audio amplifier and speaker and/or audio jack), and additional storage 1128. Other configurations may also be employed.

Embodiments of the present technology are disclosed herein in the context of a content sharing system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application—and business—related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. One or more tangible computer-readable storage media storing computer executable instructions for performing a computer process on a computing system, the computer process comprising:
graphically representing one or more members of a user's network together with a content;
receiving a user input from the user with respect to the graphical representation of the content, the user input having a directionality; and
communicating the content to a member of the user's network represented by a direction represented by the directionality.

2. The one or more tangible computer-readable storage media of claim 1, wherein the content is at least one of (1) a user generated content (UGC); (2) a content from a website; (3) a content stored on the user device; and (4) a network content downloaded from a network.

3. The one or more tangible computer-readable storage media of claim 1, wherein graphically representing one or more members of a user's network together with the content further comprises graphically representing one or more members of a user's network together with the content using at least one of (1) a tablet device; (2) a smartphone; and (3) a computer.

4. The one or more tangible computer-readable storage media of claim 1, wherein the computer process further comprising allowing the user to add an object to the content, the object being at least one of (1) an audio content, (2) a video content, (3) an audio-visual content, (4) a pictorial content; and (5) a combination content.

5. The one or more tangible computer-readable storage media of claim 1, wherein the computer process further comprising determining a relationship health score between the user and a member of the user's network based on interactions between the user and the member.

6. The one or more tangible computer-readable storage media of claim 5, wherein the computer process further comprising changing a display of the member of the users' network based on the relationship health score.

7. The one or more tangible computer-readable storage media of claim 1, wherein the computer process further comprising:
receiving an updated content from the member of the user's network;
modifying the graphical representation of the content with the graphical representation of the updated content; and
modifying one or more metadata attached to the content.

8. The one or more tangible computer-readable storage media of claim 1, wherein communicating the content to a member of the user's network further comprising:
determining network connectivity of the user;
if the user has network connectivity, communicating the content to the member of the user's network, and
if the user does not have network connectivity, storing the content to a user device.

9. The one or more tangible computer-readable storage media of claim 1, wherein the computer process further comprising:
if the user does not have network connectivity:
monitoring the network connectivity of the user, and
communicating the content from the user device to the member of the user's network upon detecting activation of the network connectivity of the user.

10. The one or more tangible computer-readable storage media of claim 1, wherein the computer process further comprising determining the one or more members of the user's network based on a geographic distance of the one or more members from the user.

11. The one or more tangible computer-readable storage media of claim 1, wherein the computer process further comprising determining the one or more members of the user's network based on an affiliation of the one or more members in a group related to the user.

12. One or more tangible computer-readable storage media storing computer executable instructions for performing a computer process on a computing system, the computer process comprising:
graphically representing one or more members of a user's network together with a content and a graphical representation of a resource;
receiving an input from the user with respect to the graphical representation of the resource, the input having a directionality;
communicating the resource to a member of the user's network displayed in a direction represented by the directionality; and
modifying the graphical representation of the resource to show the resource being unavailable to a user.

13. The one or more tangible computer-readable storage media of claim 12, wherein the resource is further configured to allow the user to make a change to the content.

14. The one or more tangible computer-readable storage media of claim 12, wherein the communicating the resource represents gifting of the resource to the member such that the user is unable to use the resource to make changes to the content.

15. The one or more tangible computer-readable storage media of claim 12, wherein the communicating the resource represents lending of the resource to the member such that the user is unable to use the resource to make changes to the content until the resource is communicated back from the member to the user.

16. The one or more tangible computer-readable storage media of claim 12, wherein the communicating the resource represents at least one of (1) a lending of the resource to the second member such that such that the user is unable to use the resource to make changes to the content for a period of time and (2) a lending of the resource to the member if a geographical distance between the user and the member is less than a predetermined threshold.

17. The one or more tangible computer-readable storage media of claim 12, wherein the computer process further comprising:
determining a geographical distance between the user and the member; and
if the geographical distance between is below a threshold distance; communicating the resource back from the member to the user.

18. The one or more tangible computer-readable storage media of claim 12, wherein the input is at least one of (1) a pinching gesture using two fingers; (2) a double-click using a mouse; (3) a single-tap on the content, and (4) a double-tap on the content using two fingers, (5) a swiping gesture.

19. One or more tangible computer-readable storage media storing computer executable instructions for performing a computer process on a computing system, the computer process comprising:
graphically representing a content and a member network using graphical representation of one or more members of the member network, wherein the graphical representation of the member network is at an initial prominence level compared to the content;
receiving a user input from a user with respect to the graphical representation of the content; and
in response to the user input, displaying the member network at a prominence level higher than the initial prominence level with respect to the graphical representation of the content.

20. The one or more tangible computer-readable storage media of claim 19, wherein the content is at least one of (1) a user generated content (UGC); (2) a content from a website; (3) a content stored on the user device; and (4) a network content downloaded from a network.

21. The one or more tangible computer-readable storage media of claim 19, wherein displaying the member network at a prominence level higher than the initial prominence level with respect to the graphical representation of the content further comprising simultaneously displaying the graphical representation of the content in a smaller size compared to a size of the graphical representation of the content before receiving the user input and displaying the graphical representation of the first member of the user's network in a larger size compared to a size of the graphical representation of the first member of the user's network before receiving the user input.

22. A method comprising:
graphically representing one or more members of a user's network together with a content;
receiving a user input from the user with respect to the graphical representation of the content, the user input having a directionality; and
communicating the content to a member of the user's network represented by a direction represented by the directionality.

23. The method of claim 22, wherein the content is at least one of (1) a user generated content (UGC); (2) a content from a website; (3) a content stored on the user device; and (4) a network content downloaded from a network.

24. The method of claim 22, further comprising allowing the user to add an object to the content, the object being at least one of (1) an audio content, (2) a video content, (3) an audio-visual content, (4) a pictorial content; and (5) a combination content.

25. The method of claim 22, further comprising determining a relationship health score between the user and a member of the user's network based on interactions between the user and the member and changing a display of the member of the users' network based on the relationship health score.

26. The method of claim 22, further comprising:
receiving an updated content from the member of the user's network;
modifying the graphical representation of the content with the graphical representation of the updated content; and
modifying one or more metadata attached to the content.

27. The method of claim 22, wherein communicating the content to a member of the user's network further comprising:
determining network connectivity of the user; and
if the user has network connectivity, communicating the content to the member of the user's network, and
if the user does not have network connectivity:
storing the content to a user device, monitoring the network connectivity of the user and communicating the content from the user device to the member of the user's network upon detecting activation of the network connectivity of the user.

28. A method comprising:
graphically representing one or more members of a user's network together with a graphical representation of a resource;
receiving an input from the user with respect to the graphical representation of the resource, the input having a directionality;
communicating the resource to a member of the user's network displayed in a direction represented by the directionality; and
modifying the graphical representation of the resource to show the resource being unavailable to a user.

29. The method of claim 28, wherein the communicating the resource represents gifting of the resource to the member such that the user is unable to use the resource to make changes to the content.

30. The method of claim 28, wherein the communicating the resource represents a lending of the resource to the second member such that such that the user is unable to use the resource to make changes to the content for a period of time.

31. The method of claim 28, wherein the communicating the resource represents a lending of the resource to the member if a geographical distance between the user and the member is less than a predetermined threshold.

32. The method of claim 28, wherein the computer process further comprising communicating the resource back from the member to the user if the geographical distance between is below a threshold distance.

33. A method comprising:
graphically representing a content and a member network using graphical representation of one or more members of the member network, wherein the graphical representation of the member network is at an initial prominence level compared to the content;
receiving a user input from a user with respect to the graphical representation of the content; and
in response to the user input, displaying the member network at a prominence level higher than the initial prominence level with respect to the graphical representation of the content.

34. The method of claim 33, wherein the content is at least one of (1) a user generated content (UGC); (2) a content from a website; (3) a content stored on the user device; and (4) a network content downloaded from a network.

35. The method of claim 33, wherein graphically representing the content and the member network further comprises graphically representing one or more members of a user's network together with the content using at least one of (1) a tablet device; (2) a smartphone; and (3) a computer.

36. An apparatus comprising:
a graphical user interface (GUI), the GUI comprising a graphical representation of a content and graphical representations of one or more members of a user's network;
a receiving mechanism configured to receive a user input indicating selection of the content;
an analysis mechanism configured to analyze the user input to determine a directionality of the user input; and
a communicating mechanism configured to communicate the content to a member of the one or more members of a user's network, the member being represented by the directionality.

37. The apparatus of claim 36, wherein the receiving mechanism further comprises a mechanism to receive a user input in the form of at least one of (1) a swiping gesture on the GUI; (2) a single-tap input on the GUI; (3) a double-tap on the GUI using two fingers; and (4) a pinching gesture on the GUI using two fingers.

38. The apparatus of claim 36, wherein:
the analysis mechanism is further configured to analyze the user input to determine a pinching gesture and in response to the pinching gesture displaying the user's network at a prominence level higher than an initial prominence level with respect to the graphical representation of the content.

39. An apparatus comprising:
a graphical user interface (GUI) configured to graphically representing one or more members of a user's network together with a content and a graphical representation of a resource;
a receiving mechanism configured to receive an input from the user with respect to the graphical representation of the resource, the input having a directionality;
a communicating mechanism configured to communicate the resource to a member of the user's network displayed in a direction represented by the directionality; and
a modification mechanism configured to modify the graphical representation of the resource to show the resource being unavailable to a user.

40. The apparatus of claim 39, wherein the communicating mechanism is further configured to disable the to use the resource to make changes to the content until the resource is communicated back from the member to the user.

41. The apparatus of claim 39, further comprising:
a geographical positioning mechanism to determine a geographical distance between the user and the member, and wherein the communicating mechanism is further configured to communicate the resource back from the member to the user if the geographical distance between is below a threshold distance.

42. The apparatus of claim 39, wherein the communicating mechanism further configured to communicate the resource to the member using at least one of (1) e-mail, (2) text message, and a social network home page of the member.

43. The apparatus of claim 39, wherein the communicating mechanism further configured to:
receive an updated content from the member via at least one of (1) e-mail, (2) text message, and a social network home page of the user; and
seamlessly update the GUI using the updated content.

44. An apparatus comprising:
a graphical user interface (GUI) configured to graphically represent a content and a member network using graphical representation of one or more members of the member network, wherein the graphical representation of the member network is at an initial prominence level compared to the content; and
a receiving mechanism configured to receive a user input from a user with respect to the graphical representation of the content;
wherein the GUI is further configured to display the member network at a prominence level higher than the initial prominence level with respect to the graphical representation of the content, in response to the user input.
